(19) United States
(12) Patent Application Publication
(10) Pub. No.: US 2004/0075237 A1
(43) Pub. Date: Apr. 22, 2004

(54) Mobile self-recovery chair

(76) Inventor: Terry L. Beck, Renton, WA (US)

Correspondence Address: Terry L. Beck, 15292 Maple Drive, Renton, WA, 98058, US

(21) Appl. No.: 10/277,315

(22) Filed: Oct. 22, 2002

(51) Int. Cl. B62M 1/14

(52) U.S. Cl. 280/250.1

(57) ABSTRACT

A self-recovery lift chair that provides an improved way for an individual who has fallen to return to a seated position and then be able to stand or wheel to another location. The chair includes a lift frame with wheels to allow for mobility, a seat that moves vertically from contact with the floor to variable or above normal seat heights. A lift mechanism comprised of a lifting trolley, which connects to the seat, a reversible drive mechanism, and a detachable actuation means that can be operated by the user or assistant. For safety of the individual and or assistant, brakes keep the chair stationary until it is necessary to be moved, and a pivoting handle allows the lift chair to be moved like a wheel chair or when turned outward as a support point for the assistant during manually assisted transfers. A rechargeable battery provides the lift chair with safe power anywhere.

### CROSS-REFERENCE TO RELATED APPLICATIONS

Not applicable

### FIELD OF INVENTION

The invention herein relates to improvements in and relating to a lift chair, more precisely a wheeled lift chair, used by an individual who has fallen to the floor, and is too weak or stiff to get up by any means, to be able to slide himself or herself onto the seat of the lift, where he or she can be raised to a normal or above normal seat height, where they can stand by themselves, or wheel themselves to a place where they may summon help.

The invention herein also relates to assistive devices, more precisely injury prevention devices that protect healthcare providers from injuring their back, neck and shoulders while attempting to lift someone off of the floor.

### BACKGROUND DESCRIPTION OF THE PRIOR ART

The Center for Disease Control reports that one in three adults over the age of 65 will fall annually, and that one half of them will suffer repeat falls. With each decade of life this percentage increases. They have reported that 50% of the people who fall and are unable to get up for just a few hours, will die within 6 months, and that 40% of all extended care admissions are because of repeat falls and that for every 1000 extended care residents there will be 1600 falls a year.

Alarming statistics of an aging population that will double between the year 2000 and 2016. This problem and the costs associated with it are draining the healthcare system of 20 billion dollars a year as of the year 2000 and are expected to reach 32 billion dollars by 2020.

The statistic while alarming do not tell the entire story of the fear, loss of autonomy and the disruption of lives that chronic falls cause. With diseases such as diabetes on the rise there will be an ever-increasing number of falls do to the peripheral neuropathies and weakness. These neuropathies while not life threatening do lead to loss of feeling in the legs and combined with decreases in visual acuity lead to many falls which an individual can not get up from. When this happens and there is a spouse available to help them back up the spouse invariably gets injured, further decreasing the couples overall quality of life.

Several inventors have created lifts that have to do with assisted transfers from one object to another, but only one addresses the need to recover someone from the floor. The prior art discloses one patent to Hough, U.S. Pat. No. 5,816,655 that addresses a vertical lift chair that an individual could scoot into from the floor and be raised to a seated height. This chair lacks the ability to be moved from one location to another with the person in the chair or out. As falls usually exhaust an individual from the exertion of trying to get up, it is typical for these individuals to need to return to bed to rest before they can walk again. This prior art demands that the individual be capable of walking away from the lift, which they may not be able to do.

The prior art of Hough also has serious safety issues with major shear points between the seat arms and the surrounding lifting frame where an arm or hand could be caught as the lift is raised.

The sliding protective plates used to hide the mechanical workings will eventually snag an article of clothing and cause serious injury. The basic design of this feature may lead to binding over time due to the inherent complexity of the design. Also the fabric used to cover the motor and drive mechanism will create an environment where someone trying to stand is going to trap his or her foot between the frame and cloth and suffer another fall. The fabric also lies in close proximity to the rotating drive mechanisms and could become wrapped in the mechanism thus rendering the chair inoperative.

A non-structural problem also exists in the prior art of Hough. In today's world of medical third party payers, a requirement exist for such a lift to be equipped with wheels in order to be reimbursed by an insurer. Without meeting this requirement most of the older or handicapped individuals will be denied access to this useful device due to financial reasons.

The prior art of Allred, U.S. Pat. No. 5,800,016 demonstrates a vertical lifting chair with wheels. The art demonstrates that it does not provide the capability to pick someone up from the floor, nor was it intended to do so. The prior art of Allred does not discuss a braking method to keep the chair stationary during transfers, which is a major safety concern.

Other prior art demonstrates a variety of vertical lifts for the handicapped. They address the need to assist a person out of a chair, or up and down in the bath, or pool, or in and out of bed. There are a number of lifts designed to lift people and wheelchairs in and out of vehicles or up and down stairs using a variety of propulsion mechanisms be it drive screws and reduction gears, levers, pneumatics and hydraulic cylinders and combinations of all of the aforementioned. They do not address the need for an individual who is alone to get up after a fall.

### SUMMARY

It is the object of the invention to provide a mobile self-recovery lift-chair that provides an individual who has fallen to the floor the ability to get to a seated position whereby he or she can stand independently. The invention is also designed to decrease the incidence of injury to caregivers while attempting to lift someone from the floor.

### Objects and Advantages

Accordingly, besides the objects and advantages of a mobile self-recovery lift described in my above patent, several objects and advantages of the present invention are.

(a) to provide a mobile lift chair that one person can use to get up from the floor and regain their ambulatory status.

(b) to provide a mobile lift chair that is ultimately safe for compromised individuals. Individuals, with diabetes, or multiple sclerosis, who have peripheral neuropathies, poor eye sight and poor balance who might catch clothing, or body parts in or on the lift because of their disabilities.

(c) to provide a mobile lift chair that when raised will stay stationary if the person trying to stands thrust backward or strongly to one side.

(d) to provide a mobile lift chair that can be moved room to room, or up and down stairs or outside.

(e) to provide a mobile lift chair that someone can use to move him or herself from place to place.

(f) to provide a mobile lift chair that is narrow enough to fit through narrow doorways, as seen in bathrooms, and yet wide enough to accommodate obese individuals. It will also be small enough to be unobtrusive in the home or hospital.

(g) to provide a mobile lift chair that sits flush with the ground, allowing someone to scoot onto the seat easily, and when raised to be higher than normal seat height so as to decrease the amount of strength it takes to stand.

(h) to provide an assistive device to care centers, hospitals and homes where it is necessary to quickly get someone off of the floor safely.

(i) to provide a mobile lift chair that is small, light, mobile and have as few pinch or entrapment places as possible and provide physical safety to the operators.

(j) to provide a mobile lift chair useable in wet areas where shock is possible. To this end the invention is equipped with an onboard rechargeable battery to provide a safe electrical source to the motor. This has the added advantage that if the power should go out in the home, the lift will continue to be functional.

(k) to provide a mobile lift chair that moves slowly from the down position to the up position so as not to frighten someone. By going slowly the individual will be able to reposition themselves on the chair as it rises and their legs become more mechanically efficient.

(l) to provide a mobile lift chair that provides support holds for people who are assisting in transfers. This is accomplished by allowing the handles on the lift frame to be turned outward. By doing this, one hand can be positioned on the handle while the other is used to lift the fallen individual, thereby relieving the strain on the assistants back, neck, and shoulders and reducing the likelihood of injury.

(m) to provide a mobile lift chair that can be used to pickup and carry heavy objects from the floor to a height where a weakened individual can handle them in a more ergonomic manner.

(n) to provide a mobile lift chair that is easy to build, durable, reliable, safe, and inexpensive.

(o) to provide a mobile lift chair that insurance companies will help pay for so the people who need them will have access to them.

Further objects and advantages of my invention will become apparent from a consideration of the drawings and ensuing description.

### DRAWINGS FIGURES

In the drawings: closely related figures have the same number but different alphabetic suffixes.

FIG. 1 shows a perspective view of a mobile self-recovery device having lift means according to the invention with a seat in the raised position.

FIG. 2 shows a perspective view of a mobile self-recovery device of FIG. 1 showing the seat in the down position, with the left handle rotated.

FIG. 3 shows a perspective view of a mobile self-recovery device of FIG. 1 with the seat, left rear wheel and front covering removed, illustrating a lifting means and location of a wheel braking mechanism.

FIG. 4 shows a perspective view of a mobile self-recovery device with seat sectioned to demonstrate relationship of seat to lift trolley and lift arms.

FIG. 5 shows a rear perspective view from the illustrating rear covering, motor placement, and optional mounting of a potential energy source.

FIG. 6 shows a sectioned front elevation of a lift frame and lift trolley of the mobile self-recovery device.

FIG. 7 shows a partial, part, sectional perspective view of a hub braking mechanism with the wheel removed.

FIG. 8 shows a sectioned perspective view of a brake handle, showing the attachment of the brake cable and release knob.

FIG. 9 shows a partial sectioned front view of an alternative embodiment of a lifting frame and lift trolley.

FIG. 10 shows a perspective view of an alternative seat means for a mobile self-recovery device, which employs a fold down

FIG. 11 shows a perspective view of an alternative lift trolley.

FIG. 12 shows a partial, part section of an alternative seat means as illustrated in FIG. 10, showing lift trolley with lift arm being used as a pivot point of the seat.

### REFERENCE NUMERALS IN THE DRAWINGS

10 lift chair

12 lift frame

14ab lift frame sides

16 top cross-member

18 bottom cross-member

20ab legs

22ab rear wheels

24ab front wheels

26 seat

28 seat platform

30ab seat arm

32 seat back

34ab flex-guard

36ab handles

38 actuator

40 brake handles

42 lock pin

44 gear motor

46 push pin for the handle

48 handle mount

50 drive screw

52 lift trolley

54ab horizontal strut

56ab vertically dependent plate

58abcd rollers

60ab lift arms

62 upper truss

64 lower truss

66 bearing receiver

68 bearing

70ab stabilizer track

72abcd stabilizer track receiver

74 drive nut receiver

76 set screw for drive nut

78ab wheel mounts

80a front covering

80b rear covering

82 motor connecting bolt

84 motor mount washer

86 motor mount nut

88 clevis

90 drive nut

92ab rear wheel hub

94ab brake

96 brake cable

98 tensioning wire

100 brake base

102 brake release pin

104 set screw

106 return spring

108 retaining clip

110 brake pin retention slots

112 brake handle mounting plate

114 brake handle Moveable plate

116 brake pivot point

118 spring

120 spring retaining washer

122 set screw

124 wire clasp

126 electrical wire

128ab stabilizer bearing rod

130abcd rod bearing

132abcd rod bearing housing

134abcd secondary horizontal struts

136ab vertical strut

138ab end caps

140ab arm release handle

142 release handle return spring

144 spring retaining clip release rod

146 arm release rod

148abcd stabilizer rod receiver

150 potential energy source

152ab lift arm

154abc horizontal struts

156ab seat arms

158ab slots

160 seat

162 seat platform

164 seat back

166 lift trolley

### DESCRIPTION OF THE PREFERRED EMBODIMENTS

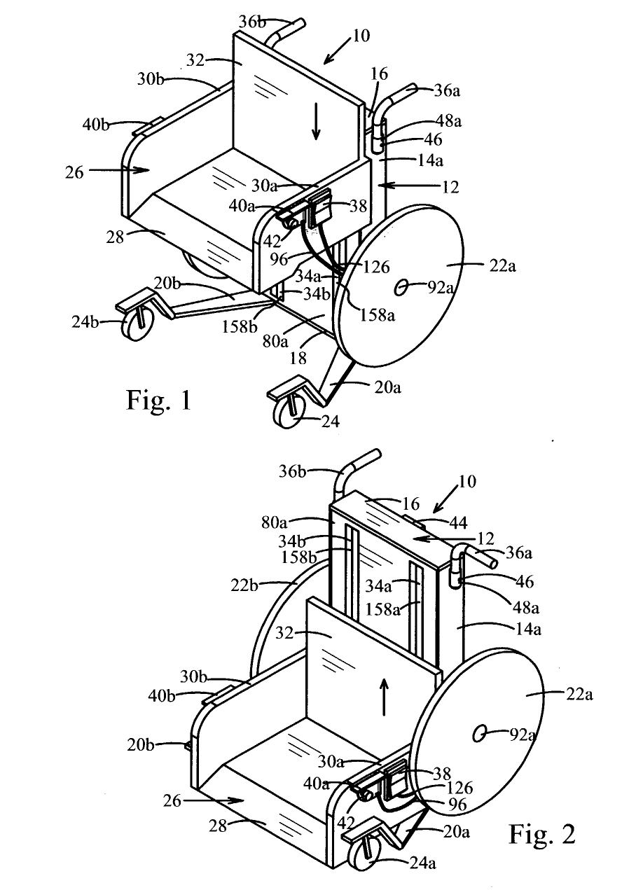

A preferred embodiment of the invention is illustrated in FIG. 1 showing a mobile self-recovery device, 10 in the raised position which can be positioned higher than standard seat height to allow easier exit, and FIG. 2 a mobile self-recovery device 10 according to the invention is shown with the seat 26 in contact with the floor showing the sloping entry to allow ease of entry.

Said invention is comprised of a lift frame 12, having a substantial right and left sides 14, solidly connected with a bottom cross member 18, which is parallel to and above the surface of the ground, and a top cross member 16 covered in the front by a suitably dense covering 80a and back 80b, as shown in Figure. Attached solidly to the bottom cross member 18, a pair of legs 20ab, project forward and laterally from a medial position on bottom cross member 18. The legs are positioned slightly above and parallel to the surface of the ground and pass under seat 26. As the legs 20ab emerge from under the seat they angle forward perpendicular to lift frame 12 and are angled upward and forward. When sufficient height is achieved to mount a front wheels 24ab, legs 20ab angle parallel to the ground. A pair of wheels 24ab, are pivotally mounted to legs 20ab. Rear wheels 22ab are mounted to the right side and left side 14ab, of lift frame 12. Solidly mounted to the top center of right and left sides 14ab, handle mounts 48ab, are solidly attached, which receives the pivotable right and left handle 36ab, held in place by spring return push pin 46.

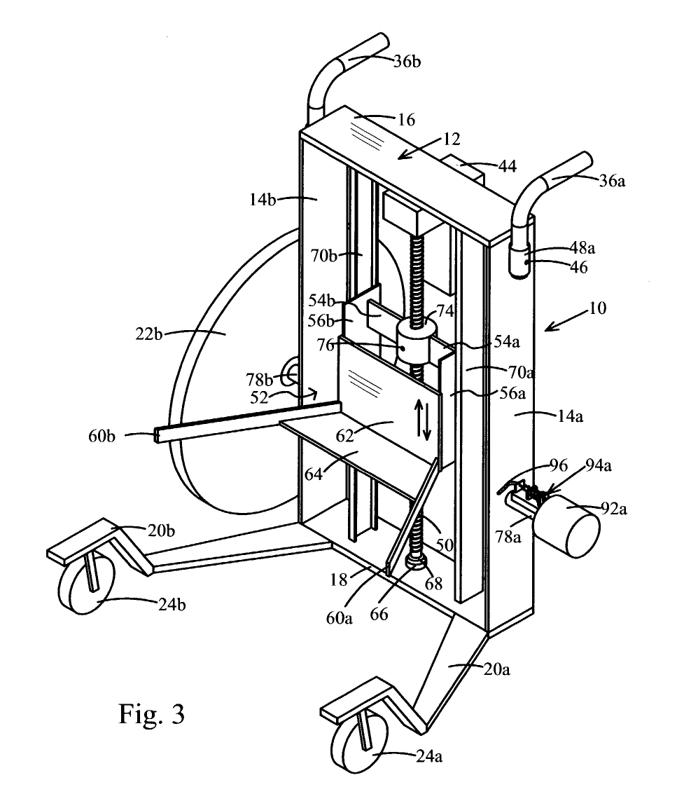

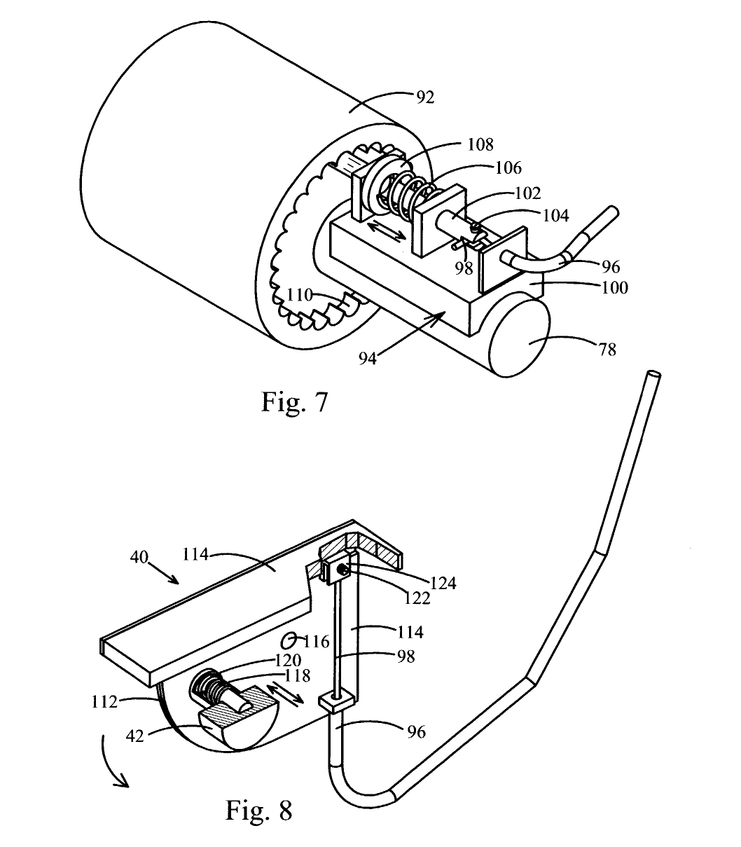

A seat 26, comprising, a seat platform 28, with an angled front to facilitate ease of entry, right and left arms 30ab, and a back 32, angling backwards and upwards is attached thereto. The seat 26 is positioned in front of the lift frame 12. Attached to the seat 26 a pair of brakes 40ab fixed to the right and left arms 30ab of the seat 26. Brakes 40ab are equipped with lock pins 42, that hold the brakes in a released position, and cable 92 that joins brake handles 40ab with brakes, shown in FIG. 3 FIG. 7 and FIG. 8, in the hub of wheel 22ab.

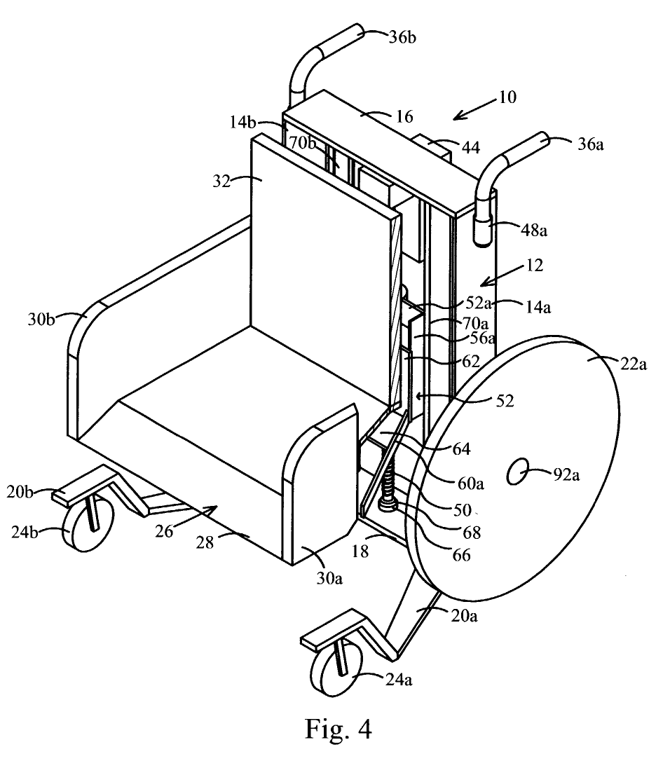

Referring primarily to FIG. 3 and FIG. 4, a lifting trolley 52, consisting of, a drive bearing receiver 74 solidly connected to right and left horizontal struts 54ab which are substantially connected to a right and left vertically dependent plates 56ab which projects forward through the front covering 80a through slots 158ab. The pair of lift arms 60ab, which are extensions of the vertically dependent plates 56ab firmly attach to seat 26, as illustrated in FIG. 4. Substantially attached between the right and left vertically dependent plates 56ab is an upper truss 62 in the vertical position, and a lower truss 64 in a horizontal position.

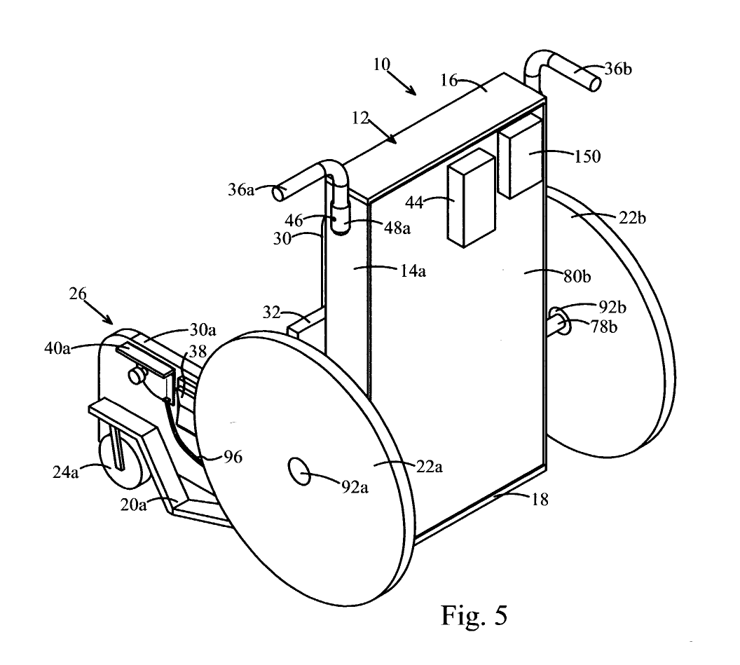

Referring particularly to FIG. 5 a rear perspective view of the mobile self-recovery chair illustrating the rear covering 80b of lift frame 12 which encloses the back of lift frame 12, motor 44 and lift trolley 52, thus keeping fingers and clothing out of that side of the lift frame 12. A rechargeable onboard potential energy source 150 is mounted to said back covering 80b as illustrated but may be mounted anywhere on the lift frame that is convenient. An actuator 38 attaching to the seat 26 with hook and loop connects an onboard battery 150, to the motor 44 with electric wire 126.

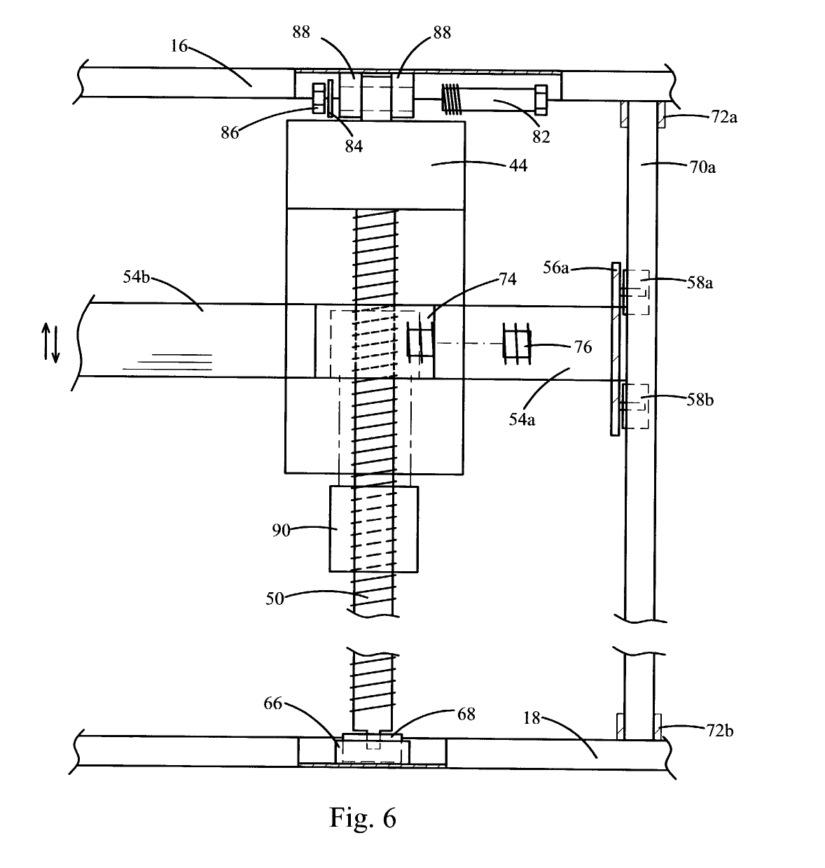

Referring particularly to FIG. 6 a partial sectional view of the lift frame 12 illustrating the mounting of a vertical rotational drive screw 50 mounted centrally in the lift frame 12 by a clevis 88 mounted gear motor 44 on the inferior surface of the top cross member 16 and connected with a bolt 82, washer 84 and nut 86, or other suitable fastening means. A suitable high density material such as Delron or a thrust bearing 68, mounted in a bearing receiver 66 is used for the inferior attachment that is substantially attached to the bottom cross member 18. This arrangement anchors the lower end of the drive shaft centrally in the bottom cross-member 18, allowing rotation in clock-wise or anti-clockwise direction. The vertically moving drive nut 90 is encased in a drive-nut receiver 74 and retained by a setscrew 76. Substantially attached to the drive nut receiver 74 a pair of horizontal struts 54ab extend to the right and left, substantially connected to the vertically dependent plates 56a and 56b, not shown. Securely fastened to the vertically dependent plates 56ab are a pair of rollers 58a, 58b, for plate 56a, and 58c, 58d, for plate 56b. The rollers 56 are staggered anteriorly at the top, and posteriorly at the bottom of the vertically dependent plates 56ab so as to contact the stabilizer tracks 70a and 70b, not shown, to permit up and down motion while maintaining the seat 26 parallel to the ground and resisting lateral and rotatory stresses if the load is not centered. The stabilizer tracks 70a and 70b, not shown, are solidly attached to the bottom cross member 18 in stabilizer track receivers 72b and 72d, not shown, and slip fit into stabilizer track receivers 72a, and 72c, not shown, in the top cross member 16.

Referring to FIG. 7, and FIG. 8, a braking mechanism, consisting of, a pair of brake handles 40ab that are firmly attached to seat arms 30ab, a pair of brakes 94ab adjustably attached to rear wheel mounts 78ab which are substantially connected to the right and left vertical side plates 14ab of lift frame 12. The brakes 94ab and brake handles 40ab are joined by brake cable 96 with internal tensioning wire 98. The adjustability of the brakes 94ab on the wheel mounts 78ab allow the brakes to adjusted in relationship to the wheel hub 92ab by brake base plate 100. A brake release pin 102 is held in one of a plurality of brake pin retention slots 110 by spring 106 and retaining clip 108. The release pin centers in the retention slots 110 in the hub 92ab of the rear wheel 22ab and is withdrawn from the brake retention slots 110 as tension wire 98, secured in a slot in the brake release pin 102 by a setscrew 104, is tensioned in cable 96 by the depression of the brake handles 40ab. This releases the brakes and the lift chair may be easily moved.

The brake handles 40ab are comprised of a fixed mounting plate 112 and a moveable plate 114 that are pivotally attached around pivot point 116. A wire clasp 124 and a setscrew 122 attach the tensioning wire 98 to the moveable plate 114. A spring 118 and retaining clip 120 give inward force to the pull pin 42 causing the pull pin to drop into a hole in the fixed plate 112 when the brake handles 40ab are pivoted about the pivot pin 116.

### ADDITIONAL EMBODIMENTS

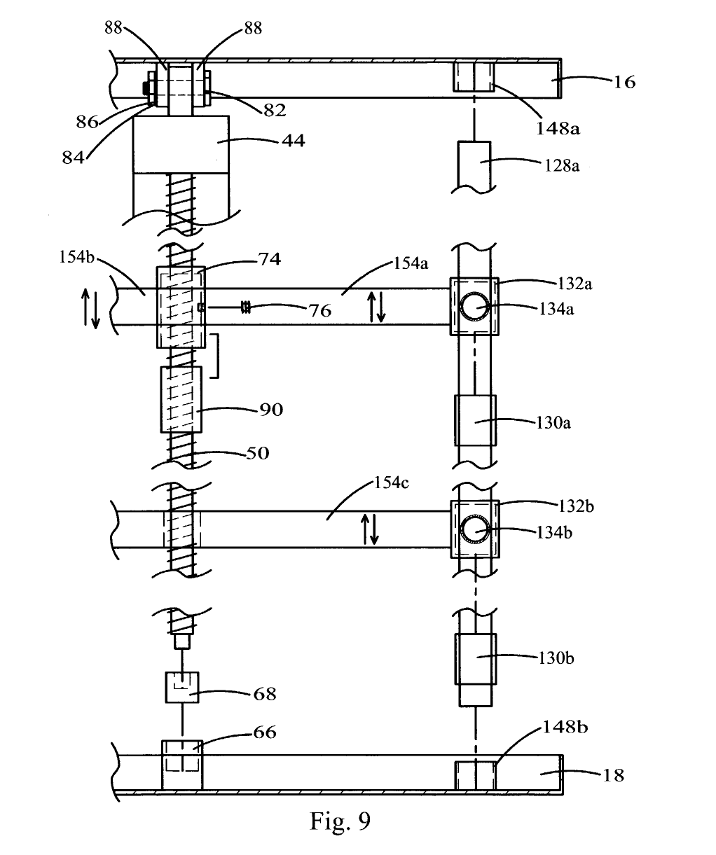

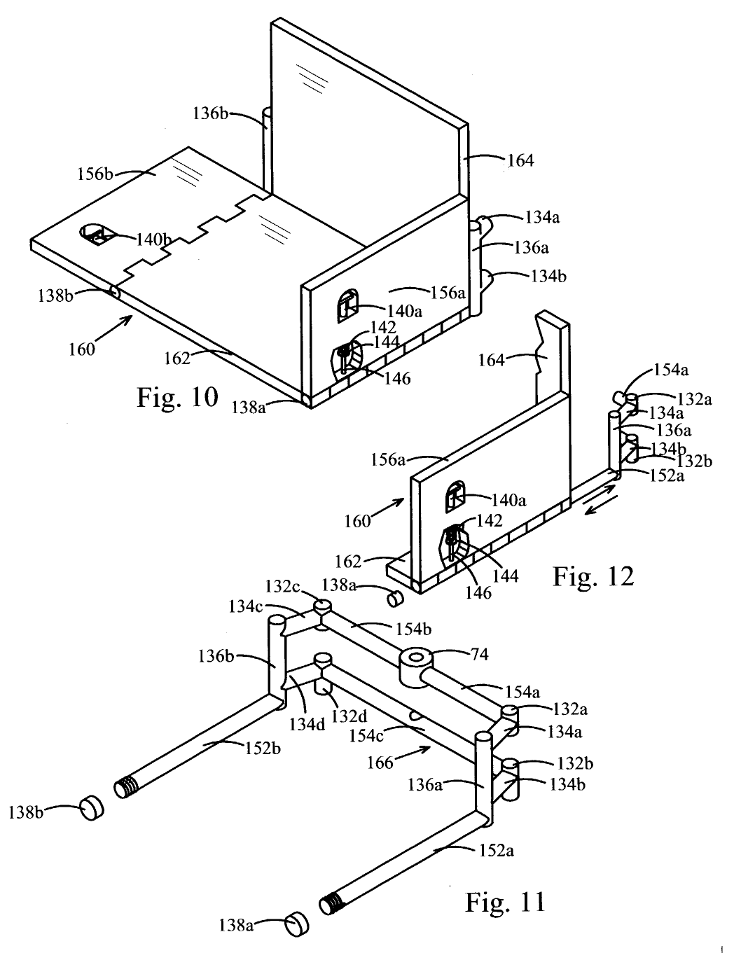

Referring primarily to FIG. 9, FIG. 10, FIG. 11, and FIG. 12, an alternative lift means comprised of, a gear motor 44, drive screw 50, drive nut 90 and drive nut receiver 74, as previously described, utilizing a pair of horizontal struts 154ab and a single strut 154c substantially connected to a plurality of bearing housings 132abcd that retain rod bearings 130abcd. A pair of stabilizer bearing rods 128a and 128b, not shown, mount in stabilizer rod receiver 148ab and 148cd, not shown. Mounted in the top cross member 16 and bottom cross member 18 the stabilizer bearing rods 128ab insert into rod bearings 130abcd which are retained in bearing housings 132abcd allowing motion up and down while keeping the seat 160 parallel to the ground. The drive screw 50 passes through a hole in the horizontal strut 152c. Projecting forward from each bearing housing 132abcd, a secondary horizontal strut 134abed substantially connects with a vertical strut 136ab as seen in FIG. 10, FIG. 11, and FIG. 12. Each pair of the secondary horizontal struts 134 connects with one vertical strut, 134ab with 136a, and 134cd with 136b to comprise one side of said lift trolley 166. Substantially attached to each of the vertical struts 136ab is a lift arm 152ab , which become the mounting points for seat 160.

FIG. 10, and FIG. 12 illustrates a right and left seat arm 156ab that can be rotated from its vertical position to a horizontally dependent position or to a horizontal adjustable position so as to be used as a sliding board to transfer someone who is too weak to stand. The right and left arms 156ab pivot around the lift arms 152ab and have a vertical locking means consisting of an arm release handle 140ab, a handle release return spring 142, a spring retaining clip 144, and an arm release rod 146. The arms 156ab may be released by lifting the arm release handle 140ab that pulls a release rod 146 out of a hole in lift arm 152ab allowing it to rotate. The arms 156ab and seat platform 162 are connected with interlacing fingers sliding onto the lift arms 152ab being retained by an end cap 138ab. This arrangement allows for a smooth platform to slide over during sliding transfers.

### Advantages

From the description above, a number of advantages of my mobile lift chair become evident:

(a) Of foremost importance, by providing wheels and braking means the mobile lift chair should qualify for insurance reimbursement, meaning that the people who have marginal resources, and who need this lift to stay at home, and out of a hospital, have access to the device.

(b) By the placement of the seat forward from the lift frame, enclosing the moving parts, and routing the legs of the lift frame under the seat until they exit at the last possible point, the seat has been designed to eliminate a point where an entrapment injury could occur.

(c) By placing the seat forward from the lift frame the width of the seat could be kept wide and the frame could be kept narrow. This allows for movement through most doors, while at the same time allowing all but the largest of individuals the ability to get into the seat. It is small enough to be unobtrusive in the home or hospital setting.

(d) By utilizing pivotable handles on the mobile lift chair the lift chair can be taken up and down stairs or onto rough surfaces similar to a standard wheelchair. With the ability of the handles to pivot outwardly, a caregiver has a counter-point of weight distribution to decrease the chance of personal injury during an assisted lift onto the seat. This arrangement also allows for control of the chair while placing someone in it. In a hospital setting it allows one person to safely do the work of two in picking someone up, and to do it quickly and efficiently.

(e) By providing an onboard rechargeable battery the lift is always ready to be used, even if the electricity is off, and it is safe to use in wet areas, such as bathrooms where many falls take place.

(f) The overall foot print of the chair gives stability even when the most awkward of transfers are attempted. The importance of this feature cannot be overstated, as individuals with neurologic disorders will thrust strongly posterior and off to one side during attempts to stand.

(g) By providing wheels the chair can be used for not only lifting and moving humans but goods placed upon it and raised may be moved around.

(h) The seat may be used by a weakened individual to do low tasks, which they otherwise could not do.

(i) In the alternative embodiment where a fold down arm is supplied, a sliding board transfer becomes possible where a standing pivot transfer is difficult or impossible.

### Operation

The manner of using the mobile lift chair is for someone who has fallen to crawl if necessary to the lift chair and slide onto the seat 26. When established upon the seat, they press the actuator 38 to create up or down movement of the seat. When a comfortable height is reached they can exit the chair. If need be, they can disengage the brakes 94 and move about in the chair much the same way someone in a wheelchair would, either to summon further assistance or to transfer to a more comfortable surrounding where they can rest and recover.

If an assistant is available the mobile lift chair 10 can be brought to the fallen individual and they can be assisted onto the seat 26 and raised by the assistant using the removable actuator 38. If strong assistance is needed the assistant may pivot the handles 36 and use them to help lift the individual onto the seat 26 while protecting their back. Again, if necessary, they can be wheeled about like a person in a wheelchair by pivoting the handles 36 back to where they protrude behind the lift frame 12.

Using an alternative embodiment of the seat 26 an assistant or individual may lift the arm release handle 140ab and pivot arm 156ab onto a surface like a bed and do a sliding board transfer.

### Conclusion, Ramifications, and Scope

Thus the reader will see that the mobile lift chair provides a safe, reliable, durable, easy to build and cost effective way to get someone off of the floor, either independently or with assistance. It provides safety and security to all parties involved in it's use and should decrease the number of injuries to healthcare workers and the unnecessary hospitalizations of individuals because they have recurrent falls.

In hospital settings where falls are a daily occurrence, the need to quickly and efficiently pick someone up and put them to bed can be met with the mobile lift. It is small enough and agile enough to be moved between beds and into bathrooms where the individual can be scooped up, and transferred with a minimum of effort.

Although the description above contains many specificities, these should not be construed as limiting the scope of the invention but as merely providing illustrations of some of the presently preferred embodiments of this invention. For the current description, metals, such as aluminum or steel are foreseen as the most obvious choices for the lifting structure. The seat can be made from injected molded plastic, glass reinforced plastic or composite materials. It is possible that the entire lift chair could be constructed of dense injection molded plastic which would facilitate mass production, weight and costs savings as well as changing the configuration of the lift frame and lift means.

The drive mechanism of a gear motor and drive screw with drive nut was chosen over a hydraulic or pneumatic, cable or chain propulsion devices due to safety, cost and weight concerns. The gear motor, drive screw combination is the most efficient, affordable, durable, and light weight of all of the options.

Thus the scope of the invention should be determined by the appended claims and their legal equivalents, rather than by the examples given.

I claim

1. A self-recovery device for lifting a fallen human from the ground having improvements wherein said self-recovery device is mobile.
(a) A frame with legs protruding from the front, having wheels rotatably attached to said frame and pivotably attached to said legs thereby allowing said frame to be moved along a surface.
(b) A seat moveably attached to said frame.
(c) Means for moveably coupling said seat to said frame.
(d) A motor mounted in said frame providing rotational energy to move said coupling means up and down in said frame.
(e) Brake means to keep frame stationary until ready to be moved.
(f) Actuator means connecting potential energy means with said motor.
(g) Handle means pivotably connected to said frame,
wherein said self-recovery device has the improvements of being moveable with the individual in or out of said seat and stationary when lifting and transferring are required,

2. The mobile self-recovery device as declared in claim 1 wherein said frame is comprised of a left vertically depending side, a right vertically depending side connected to a top cross member, and substantially connected to a bottom cross member, a pair of legs angularly projecting forward from said bottom cross member.

3. The mobile self-recovery device as declared in claim 1, wherein said seat is comprised of a beveled bottom plate, a right upwardly depending plate, a left upwardly depending plate and an upwardly depending back rigidly attached thereto.

4. The mobile self-recovery device as declared in claim 1, in which said lift means comprised of a plurality of vertical control tracks with means for attachment to said top cross member and said bottom cross member, a plurality of horizontal struts substantially attached to a drive nut housing and vertical support plates with mounted rollers that ride in said tracks providing vertical movement and controlling motion of said seat.

5. A mobile self-recovery device as declared in claim 1, wherein drive means comprising, a motor, transmission, drive screw and a drive nut vertically oriented in said frame fastened stably to said top cross member and rotatably to said bottom cross member,

6. A mobile self-recovery device as declared in claim 1, an actuator means comprising an onboard potential energy means, a reversible switch means which is detachable from said seat for user accessibility, activation of said switch controls rotation of said motor giving said up and down propulsion to said lift means.

7. A mobile self-recovery device as declared in claim 13, where potential energy device is rechargeable giving unlimited mobility and safety when used in wet areas.

8. A mobile self-recovery device as declared in claim 1, wherein brake means comprises, a pair of brake a pair of brake actuators attached to said seat and connected to brake means at the rear wheel hub by wire and cable means, rotation of a handle on said brake means releases said brakes making movement of said self-recovery device possible.

9. A self-recovery device for lifting a fallen human from the ground having improvements wherein said self-recovery device is ergonomically safer for an assistant.

10. A mobile self-recovery device as declared in claim 9, wherein a pair of handles pivotably attached to the top of said left vertically depending side and said right vertically depending side of said lift frame can be turned outwardly from said lift frame, by placing a hand on said outwardly facing handle, an assistant can reduce the stress on his or her body and gain leverage to pull the fallen individual onto the seat where they can be lifted and moved, or stand and walk.

12. A mobile self-recovery device as declared in claim 1 wherein said lift means articulates with said seat allowing said vertically depending plates to be rotated in a relatively horizontal plane and used as a sliding board to transfer someone who is too weak to stand wherein said sliding board arrangement imparts a further safety feature.
